(19) United States
(12) Patent Application Publication
(10) Pub. No.: US 2020/0341111 A1
(43) Pub. Date: Oct. 29, 2020

(54) METHOD AND APPARATUS FOR RADAR DETECTION CONFIRMATION

(71) Applicant: GM GLOBAL TECHNOLOGY OPERATIONS LLC, Detroit, MI (US)

(72) Inventors: Aldo P. D'Orazio, Howell, MI (US); Jason M. France, Ann Arbor, MI (US)

(73) Assignee: GM GLOBAL TECHNOLOGY OPERATIONS LLC, Detroit, MI (US)

(21) Appl. No.: 16/392,696

(22) Filed: Apr. 24, 2019

(51) Int. Cl. G01S 7/36; B60R 11/04; G01S 7/02; G01S 13/93; G01S 13/86; G01S 17/89; G01S 17/93; G05D 1/02

(52) U.S. Cl. CPC G01S 7/36; B60R 11/04; G01S 7/021; G01S 13/931; G01S 13/865; B60R 2300/8093; G01S 17/89; G01S 17/936; G05D 1/0257; B60R 2300/301; G01S 13/867

(57) ABSTRACT

The present application generally relates to a method and apparatus for obtaining crash or near crash related data in a motor vehicle. In particular, the system is operative to determine a proximity to a railway crossing in response to a vehicle location and a map, to detect an object using a radar, to confirm the presence of the object using a visual detecting system in response to the proximity to the railway crossing being less than a threshold distance, to generate a vehicle control signal in response to confirming the presence of the object using the visual detecting system, and to control an assisted driving equipped vehicle in response to the vehicle control system.

### BACKGROUND

The present disclosure relates generally to object detection systems on vehicles equipped with adaptive driver assistance systems (ADAS). More specifically, aspects of the present disclosure relate to systems, methods and devices to decrease radar target false detections near railroad crossings through detection confirmation with visual detection systems.

Modern vehicles are increasingly being equipped with adaptive driver assistance systems (ADAS) in order to provide driving control with less and less driver intervention. Vehicle automation has been categorized into numerical levels ranging from zero, corresponding to no automation with full human control, to five, corresponding to full automation with no human control. Various automated driver-assistance systems, such as cruise control, adaptive cruise control, and parking assistance systems correspond to lower automation levels, while true “driverless” vehicles correspond to higher automation levels.

Vehicles with ADAS and other active safety systems use a number of vehicular sensors to locate objects around them, such as radar, lidar, and cameras. However, when radar systems are used around large metallic objects they may return false target indications. This is increasingly problematic for railroad crossings where the false target detections from the railroad tracks or barriers structures may indicate an object in the roadway. This may result in unwanted braking at unobstructed railway crossings It would be desirable to reduce the occurrences of false braking events due to false radar object detections at railroad crossings.

The above information disclosed in this background section is only for enhancement of understanding of the background of the invention and therefore it may contain information that does not form the prior art that is already known in this country to a person of ordinary skill in the art.

### SUMMARY

Disclosed herein are object detection methods and systems and related control logic for provisioning vehicle sensing and control systems, methods for making and methods for operating such systems, and motor vehicles equipped with onboard sensor and control systems. By way of example, and not limitation, there is presented various embodiments of vehicle detection systems, target detection and confirmation are disclosed herein.

In accordance with an aspect of the present invention, an apparatus comprising a radar for detecting an object within a field of view, a camera for capturing an image of the field of view, a sensor for determining a location, a memory for storing a map, a processor for determining the presence of a railway crossing in response to the location and the map, for processing the image to confirm the presence of the object in response to a determination of the railway crossing being within the field of view, and for generating a vehicle control signal in response to the confirmation of the presence of the object, and a vehicle controller for controlling a vehicle in response to the vehicle control signal.

In accordance with another aspect of the present invention wherein a processing of the image is further performed in response to the railway crossing being less than 50 meters from the vehicle.

In accordance with another aspect of the present invention wherein the processing of the image is further performed in response to the railway crossing being less than a threshold value wherein the threshold value is calculated in response to a vehicle velocity and a distance between the vehicle and the railway crossing.

In accordance with another aspect of the present invention wherein the camera is a LIDAR system.

In accordance with another aspect of the present invention wherein the sensor is a global positioning system.

In accordance with another aspect of the present invention wherein the map is indicative of a railway crossing location.

In accordance with another aspect of the present invention wherein the processor is further operative to perform an adaptive driver assistance system algorithm.

In accordance with another aspect of the present invention wherein the control signal is indicative of a driving path of the vehicle.

In accordance with another aspect of the present invention a method comprising determining a proximity to a railway crossing in response to a vehicle location and a map, detecting an object using a radar, confirming the presence of the object using a visual detecting system in response to the proximity to the railway crossing being less than a threshold distance, generating a vehicle control signal in response to confirming the presence of the object using the visual detecting system, and controlling an assisted driving equipped vehicle in response to the vehicle control system.

In accordance with another aspect of the present invention wherein the visual detecting system is a LIDAR.

In accordance with another aspect of the present invention wherein the visual detecting system is a camera and wherein the presence of the object is confirmed in response to performing an image processing algorithm.

In accordance with another aspect of the present invention wherein the vehicle control signal is indicative of a vehicle path.

In accordance with another aspect of the present invention wherein the threshold distance is calculated in response to a velocity of the assisted driving equipped vehicle.

In accordance with another aspect of the present invention wherein the confirmation of the presence of the object is further made in response to the object being detected in a location of the railway crossing.

In accordance with another aspect of the present invention wherein detecting the object further includes determining a location of the object in response to a map.

In accordance with another aspect of the present invention a vehicle control system in a vehicle comprising a radar operative to detect the location of an object within a field of view, a camera operative to capture an image of the field of view, a global positioning sensor for determining a location of the vehicle, a memory for storing a map indicative of a location of a railway crossing, a first processor operative to generate a camera confirmation indicator in response to a distance between the location of the vehicle and the location of the railway crossing being less than a threshold distance, a processor operative to perform an image processing algorithm on the image of the field of view to confirm the location of the object in response to the camera confirmation indicator and to generate a vehicle control signal in response to the confirmation of the location of the object, and a vehicle controller for controlling the vehicle in response to the vehicle control signal.

In accordance with another aspect of the present invention wherein the threshold distance is calculated in response to a velocity of the vehicle wherein the camera confirmation indicator is further generated in response to the object being collocated with the railway crossing.

In accordance with another aspect of the present invention wherein the camera is a LIDAR and the image is a LIDAR point cloud.

In accordance with another aspect of the present invention wherein the processor is further operative to generate a vehicle path in response to the location of the vehicle, the map and a user input.

In accordance with another aspect of the present invention wherein the processor is further operative to generate a vehicle path in response to the location of the vehicle, the map and a user input and wherein the camera confirmation indicator is further generated in response to the location of the railway crossing being within the vehicle path.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an exemplary application of the method and apparatus for radar detection confirmation in a motor vehicle according to an embodiment of the present disclosure.

FIG. 2 shows a block diagram illustrating an exemplary system for radar detection confirmation in a motor vehicle according to an embodiment of the present disclosure.

FIG. 3 shows a flowchart illustrating an exemplary method for radar detection confirmation according to an embodiment of the present disclosure

FIG. 4 shows a block diagram illustrating another exemplary system for radar detection confirmation in a motor vehicle according to an embodiment of the present disclosure.

FIG. 5 shows a flowchart illustrating another exemplary method for radar detection confirmation according to an embodiment of the present disclosure

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The presently disclosed method and system are operative to detect railroad crossings and enable logic within a vehicle control algorithm to enable camera confirmation for radar detected objects near railroad crossings. This reduces the occurrences of false braking events due to falsely detected radar targets at railroad crossings. This logic is operative to detect when there is a railroad crossing present and allow the algorithm to require a fused visual and radar target for braking in order to reduce false events often seen at railroad crossings.

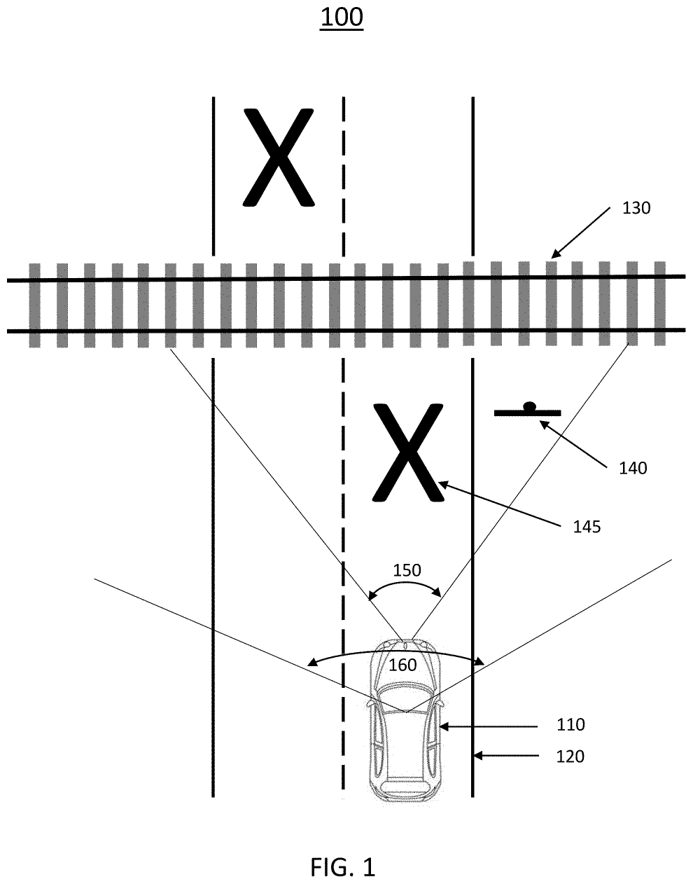

FIG. 1 schematically illustrates an exemplary application of the method and apparatus for radar detection confirmation in a motor vehicle 100 according to the present disclosure. In this exemplary embodiment, a vehicle 110 is traveling along a road 120 and has is approaching a railroad crossing 130. The vehicle 110 is equipped with a radar system having a radar field of view 150 and a camera having a camera field of view 160.

During operation, the vehicle control system within the vehicle 110 is operative to control the radar to detect objects proximate to the vehicle 110 during operation and to determine if the vehicle 110 has a clear path of travel on the road 120. In this exemplary embodiment, the vehicle 110 is approaching a railway crossing 130. The radar system is operative to transmit an electromagnetic pulse in the direction of the radar field of view 150 and to receive a reflected signal from objects within the radar field of view 150. The electromagnetic pulse may be reflected from the tracks of the railway crossing 130 and may be interpreted by the vehicle control system as an object in the roadway 120.

In response to the detection of an object in the roadway 120, the vehicle control system may then be operative to determine if the vehicle 110 is approaching a railway crossing 130. The vehicle control system may determine a proximate railway crossing in response to a global positioning system signal and map data. The map data is indicative of road locations and railway crossings. If the vehicle control system determines that the detected object is in the location of a railway crossing, the vehicle control system may enable a secondary confirmation algorithm, such as a camera confirmation algorithm.

In this example, the vehicle control system is operative to enable a camera confirmation algorithm which is operative to capture an image of the camera field of view 160. The vehicle control system may then be operative to perform image processing techniques to determine if the detected object is present near the location of the railway crossing, or if the target indication is a reflection from the railway crossing. The image processing algorithm may use information from the radar processing system, such as detected location of the object, to reduce the image processing to a specific are of the image or camera field of view 160.

Alternatively, the vehicle control system may be operative to perform an image recognition function on the image to determine the presence of the railway crossing in response to an object detection proximate to the railway crossing 130. The image recognition function may process the image to detect the presence of a railway crossing sign 140, railway crossing gate, or a crossbuck 145, or large X, painted onto the road 120 before the railway crossing 130. If the vehicle control system determines that a railway crossing 130 is present, the vehicle control system may suspect that the detected object is a false detection caused by the railway crossing 130 and may then initiate an image recognition function to confirm the presence of the detected object.

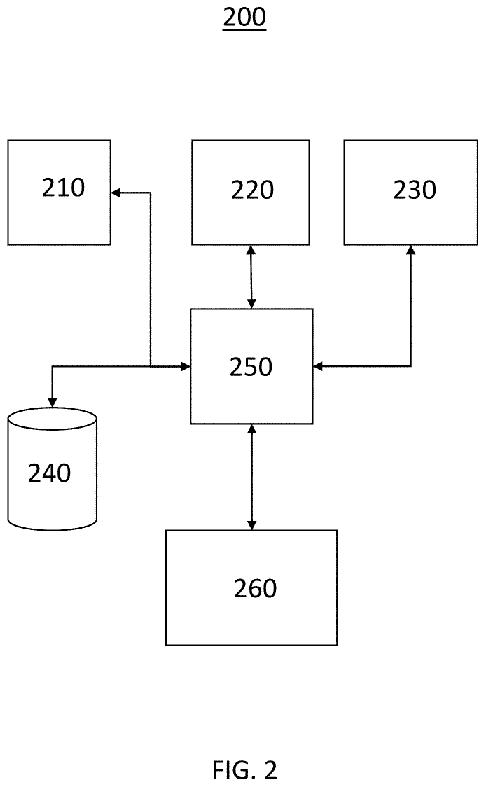

Turning now to FIG. 2, a block diagram illustrating an exemplary system 200 for radar detection confirmation in a motor vehicle is shown. The exemplary system includes a global positioning system (GPS) receiver 210, a radar system 220, a camera 230, a vehicle processor 250, a memory 240 and a vehicle controller 260. The GPS receiver 210 is operative to receive a plurality of signals indicative of a satellite location and a time stamp. In response to these signals, the GPS receiver 210 is operative to determine a location of the GPS receiver 210. The GPS receiver 210 is then operative to couple this location to the vehicle processor 250.

The radar system 220 may have one or more directional radio frequency transmitters and one or more receivers. The radar system 200 is operative to transmit a radio frequency electromagnetic pulse toward a field of view of a transmitter. An object within the field of view of the transmitter, such as another vehicle, may cause some of the transmitted pulse to be reflected back where it is received by a receiver. In response to the direction of transmitted signal and received signal, amplitude of the reflected pulse, frequency of the reflected pulse and time between transmission of the transmitted pulse and the reception of the reflected pulse, the radar system 220 is operative to determine the location of an object within the field of view. The radar system 220 may further be operative to determine a velocity of the object and to characterize the objection. Characterization of the object may include determining if the object is a vehicle, a pedestrian, a stationary object, etc. This location, velocity and characterization may be coupled to the vehicle processor 250 as a set of data or as a radar object map indicative of objects proximate to the vehicle.

The camera 230 is operative to capture an image or a series of images of a camera field of view. In an exemplary embodiment of the system 200, the field of view of the camera 230 overlaps the field of view of the radar system 220. The camera is operative to convert the image to an electronic image file and to couple this image file to the vehicle processor 250. The image file may be coupled to the vehicle processor 250 continuously, such as a video stream, or may be transmitted in response to a request by the vehicle processor 250.

In this exemplary embodiment, the vehicle processor 250 is operative to perform the ADAS algorithm in addition to other vehicular operations. The vehicle processor 250 is operative to receive GPS location information, radar data and image information, in addition to map information stored in the memory 240 to determine an object map of the proximate environment around the vehicle. The vehicle processor 250 runs the ADAS algorithm in response to the received data and operative to generate control signals to couple to the vehicle controller 260 in order to control the operation of the vehicle. The vehicle controller 260 may be operative to receive control signals from the vehicle processor 250 and to control vehicle systems such as steering, throttle, and brakes.

In this exemplary embodiment, the vehicle processor 250 is further operative to determine a proximity to a railway crossing in response to a vehicle location and a map. The vehicle processor 250 is then operative to detecting an object location in response to the radar signal. In response to detecting the objection, the processor may be operative to confirm the presence of the object using a visual detecting system in response to the proximity to the railway crossing being less than a threshold distance. The vehicle processor 250 is then operative to generate a vehicle control signal in response to confirming the presence of the object using the visual detecting system. The vehicle processor is then operative to generate a vehicle control signal, such as a vehicle driving path, to couple to the vehicle controller 260. The vehicle controller 260 is then operative to control the vehicle to execute the vehicle driving path.

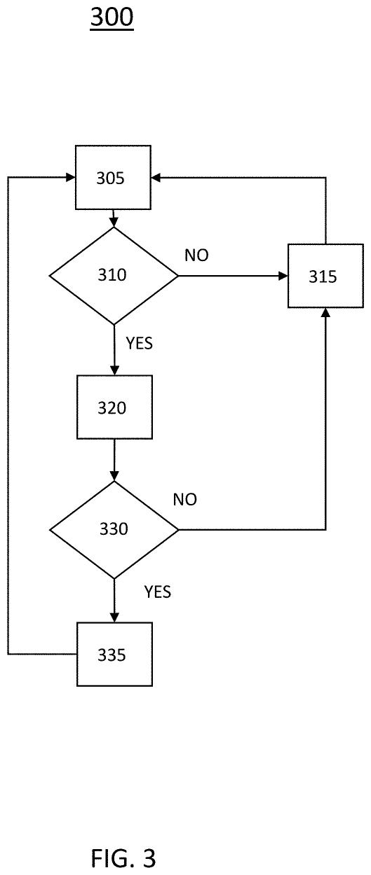

Turning now to FIG. 3, a flow chart illustrating an exemplary method 300 for radar detection confirmation in a motor vehicle motor vehicle is shown. The method 300 is first operative to receive GPS 305 data from the GPS receiver. This data may include a set of GPS coordinates indicating a location. The method is then operative to compare 310 these GPS coordinates to a map to determine if the vehicle is proximate to a railroad crossing. The vehicle may be proximate to a railway crossing if the vehicle is located within a predefined distance. For example, if the vehicle is within 50 meters of a railway crossing, the method may determine that the vehicle is proximate to a railway crossing. This distance may be adjusted with respect to vehicle speed and other factors. The distance may be increased as processing capacity is increased. For example, a vehicle processor having higher processing capabilities may use a greater distance as the processor may be able to handle increased image processing operations in addition to the vehicle control operations. If it is determined that the vehicle is not proximate to a railway crossing, the method operative to set a camera confirmation indicator to off 315 and to return to determining proximity 305 to a railway crossing.

If the method determines that the vehicle is proximate to a railway crossing 310, the method is then operative to determine the longitudinal distance to the railway crossing 320. In this exemplary embodiment, the longitudinal distance is the distance between the vehicle and the railway crossing along the driving path of the vehicle. For example, as the vehicle is travelling forward and is approaching a railway crossing, the distance is the forward distance between the vehicle and the railway crossing. The longitudinal distance is then compared to a calibrated threshold distance value to determine if the longitudinal distance is less than or equal to the threshold distance value 330. The calibrated threshold value may be adjusted in response to weather conditions, velocity of the vehicle, or other factors. If the longitudinal distance is greater than the calibrated threshold value 330, the method is then operative to set the camera confirmation indicator to off 315 and to return to determining proximity 305 to a railway crossing.

If it is determined that the longitudinal distance between the vehicle and the railway crossing is less than or equal to the calibrated threshold distance value 330, the method is then operative to set the camera confirmation indicator to on 335. The method is then operative to return to determining proximity to a railway crossing 305. The camera confirmation indicator will indicate to the vehicle processor that radar target detections must be confirmed with a visual confirmation such as through image processing techniques for determining a detected object is not a false indication from the railway crossing structure.

While the exemplary embodiment uses a forward facing camera to provide the camera confirmation other detection methods may be used. For example, a LIDAR system may be used to generate a LIDAR map of the radar field of view. The LIDAR map may then be processed to determine the presence of the detected object.

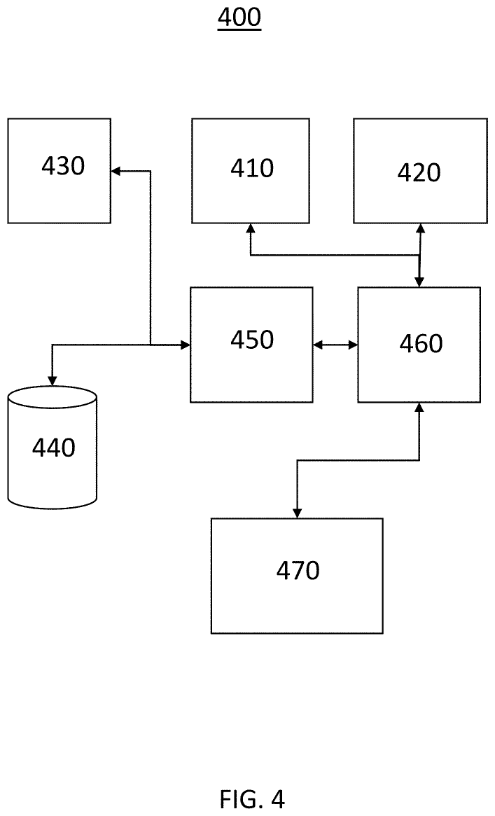

Turning now to FIG. 4 a block diagram illustrating an exemplary system 400 for radar detection confirmation in a motor vehicle is shown. In this exemplary embodiment, the system 400 is a vehicle control system in a vehicle. The vehicle control system includes a radar 410 operative to detect the location of an object within a field of view, a camera 420 operative to capture an image of the field of view, a global positioning sensor 430 for determining a location of the vehicle, and a memory 440 for storing a map indicative of a location of an area proximate to the vehicle including a railway crossing. Alternatively, a LIDAR system may be used in place of the camera 420 to generate a LIDAR point cloud of the field of view.

The system 400 includes a first processor 450 operative to generate a camera confirmation indicator in response to a distance between the location of the vehicle and the location of the railway crossing being less than a threshold distance. In this exemplary embodiment, the threshold distance may be calculated in response to a velocity of the vehicle wherein the camera confirmation indicator is further generated in response to the object being collocated with the railway crossing.

The system further includes a second processor 460 operative to perform an image processing algorithm on the image of the field of view to confirm the location of the object in response to the camera confirmation indicator and to generate a vehicle control signal in response to the confirmation of the location of the object, and a vehicle controller 470 for controlling the vehicle in response to the vehicle control signal. In this exemplary embodiment, the second processor 460 is further operative to generate a vehicle path in response to the location of the vehicle, the map and a user input. The camera confirmation indicator may also be generated in response to the location of the railway crossing being within the vehicle path.

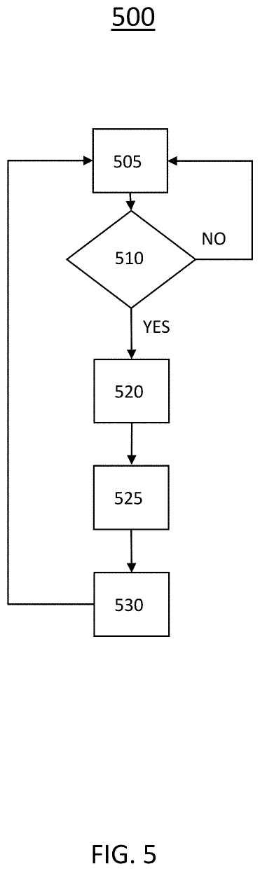

Turning now to FIG. 5, a flow chart illustrating an exemplary method 500 for radar detection confirmation in a motor vehicle motor vehicle is shown. In this exemplary embodiment, the method is first operative to detect 505 an object using a radar system. The method is then operative to determine 510 if the object is collocated with a railway crossing. The determination if the object is collocated with a railway crossing may be made in response to a location of the motor vehicle received from a GPS, a radar map generated in response to the radar system and a map stored on a memory within the motor vehicle. An object may be determined to be collocated with a railway crossing if the objects location is estimated to be within a predetermined distance of the stored location of the railway crossing, such as 10 meters or the like.

If the method determines that the object is collocated with the railway crossing, the method is then operative to confirm 520 the presence of the object using a visual detecting system. Optionally, the use of the visual detecting system may be initiated in response to the proximity to the railway crossing being less than a threshold distance in addition to the object being collocated with the railway crossing. In this exemplary embodiment, the threshold distance may be calculated in response to a velocity of the assisted driving equipped vehicle. For example, the threshold distance may be greater or longer for a faster moving vehicle and less or shorter for a slower moving vehicle. The threshold distance may be increased if the vehicle has additional processing capabilities and is able to perform the additional image processing algorithms resulting from an increased threshold distance. The visual detecting system is a LIDAR used to generate a LIDAR point cloud or may be a camera used to generate an image. The presence of the object may confirmed in response to performing an image processing algorithm on the image or through object detection techniques performed on the LIDAR point cloud.

The method is then operative to generate 525 a vehicle control signal in response to confirming the presence of the object using the visual detecting system. The vehicle control signal may be indicative of a vehicle path or may be indicative of a vehicle control action, such as steering control or brake control to be performed by a vehicle controller. The vehicle control signal may be generated in response to the object being present and a vehicle control signal indicating a path that avoids the object or indicating for the vehicle to stop before the object. If the object is not confirmed determined to be present, the vehicle control signal may be indicative of the object being removed from the radar may and may indicate that the vehicle path may proceed through the detected location of the object.

The method is then operative to control 530 an assisted driving equipped vehicle in response to the vehicle control system. This control may include controller a vehicle steering, throttle and braking systems. Alternatively, this control may involve generating additional control signals to couple to a throttle controller, steering controller and brake controller. After or during control of the vehicle, the method is then operative to return to detecting an object using the radar system 505.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An apparatus comprising:
a radar operative to detect an object within a field of view;
a camera configured to capture an image of the field of view;
a sensor configured to determine a location;
a memory operative to store a map;
a processor operative to determine the presence of a railway crossing in response to the location and the map, to process the image to confirm the presence of the object, and to generate a vehicle control signal in response to the confirmation of the presence of the object; and
a vehicle controller configured to control a vehicle in response to the vehicle control signal.

2. The apparatus of claim 1 wherein the processor is further operative to process the image is further performed in response to the railway crossing being less than 50 meters from the vehicle.

3. The apparatus of claim 1 wherein the processor is further operative to process the image is further performed in response to the railway crossing being less than a threshold value wherein the threshold value is calculated in response to a vehicle velocity and a distance between the vehicle and the railway crossing.

4. The apparatus of claim 1 wherein the camera includes a LIDAR system.

5. The apparatus of claim 1 wherein the sensor includes a global positioning system.

6. The apparatus of claim 1 wherein the map is indicative of a railway crossing location.

7. The apparatus of claim 1 wherein the processor is further operative to perform an adaptive driver assistance system algorithm.

8. The apparatus of claim 1 wherein the control signal is indicative of a driving path of the vehicle.

9. A method comprising:
determining a proximity to a railway crossing in response to a vehicle location and a map using a processor;
detecting an object using a radar;
confirming the presence of the object using a visual detecting system in response to the proximity to the railway crossing being less than a threshold distance;
generating a vehicle control signal by the processor in response to confirming the presence of the object using the visual detecting system; and
controlling an assisted driving equipped vehicle using a vehicle controller in response to the vehicle control signal.

10. The method of claim 9 wherein the visual detecting system comprises a LIDAR.

11. The method of claim 9 wherein the visual detecting system comprises a camera and wherein the presence of the object is confirmed in response to performing an image processing algorithm.

12. The method of claim 9 wherein the vehicle control signal is indicative of a vehicle path.

13. The method of claim 9 wherein the threshold distance is calculated in response to a velocity of the assisted driving equipped vehicle.

14. The method of claim 9 wherein the confirmation of the presence of the object is further made in response to the object being detected in a location of the railway crossing.

15. The method of claim 9 wherein detecting the object further includes determining a location of the object in response to a map.

16. A vehicle control system in a vehicle comprising:
a radar operative to detect the location of an object within a field of view;
a camera operative to capture an image of the field of view;
a global positioning sensor to determine a location of the vehicle;
a memory to store a map indicative of a location of a railway crossing;
a first processor operative to generate a camera confirmation indicator in response to a distance between the location of the vehicle and the location of the railway crossing being less than a threshold distance;
a processor operative to perform an image processing algorithm on the image of the field of view to confirm the location of the object in response to the camera confirmation indicator and to generate a vehicle control signal in response to the confirmation of the location of the object; and
a vehicle controller to control the vehicle in response to the vehicle control signal.

17. The apparatus of claim 16 wherein the threshold distance is calculated in response to a velocity of the vehicle wherein the camera confirmation indicator is further generated in response to the object being collocated with the railway crossing.

18. The apparatus of claim 16 wherein the camera is a LIDAR and the image is a LIDAR point cloud.

19. The apparatus of claim 16 wherein the processor is further operative to generate a vehicle path in response to the location of the vehicle, the map and a user input.

20. The apparatus of claim 16 wherein the processor is further operative to generate a vehicle path in response to the location of the vehicle, the map and a user input and wherein the camera confirmation indicator is further generated in response to the location of the railway crossing being within the vehicle path.
